(19) United States
(12) Patent Application Publication
(10) Pub. No.: US 2014/0262961 A1
(43) Pub. Date: Sep. 18, 2014

(54) SOLVENT SELECTION PROCESS

(71) Applicant: PetroSonic Energy Inc., Calgary (CA)

(72) Inventors: Art AGOLLI, Calgary (CA); Patrick Brunelle, Langdon (CA); Alfred Fischer, Calgary (CA)

(73) Assignee: PetroSonic Energy Inc., Calgary (CA)

(21) Appl. No.: 14/208,799

(22) Filed: Mar. 13, 2014

Related U.S. Application Data
(60) Provisional application No. 61/787,606, filed on Mar. 15, 2013.

(51) Int. Cl. C10G 32/00; G06N 5/04

(52) U.S. Cl. CPC C10G 32/00; G06N 5/04
USPC 208/309; 706/52

(57) ABSTRACT

A method for solvent selection to be used in asphaltene and de-asphalted oils (DAO) separation process is disclosed. Such process uses solvents and sonication in heavy oil, which is the main feedstock for asphaltenes and DAO's. The method may involve consideration of variety of factors that drive solvent selection. The method disclosed herein may be used as part of an algorithm or as part of a planning sequence for selecting the optimal solvent. Furthermore, the method may include considerations for using of a plurality of solvents to meet requested volume and characteristics of asphaltenes and DAO's.

### CROSS REFERENCE TO RELATED APPLICATIONS

This application claims priority to U.S. Provisional Patent Application Ser. No. 61/787,606, filed Mar. 15, 2013, entitled “Solvent Selection Process,” which is hereby incorporated by reference in its entirety.

### BACKGROUND

1. Field of the Disclosure

The present disclosure relates generally to the treatment of heavy oil and more particularly, to a method for solvent selection within a sonic treatment for asphaltenes separation from heavy oil.

2. Background Information

Refineries may not always be suited for processing different types of heavy oil feedstocks. Viscosity, density, asphaltenes, heavy metals, sulfur and other impurities in those feedstocks demand processing to modify and/or upgrade their chemical properties. Low viscosity is required to make them suitable for transportation, value optimization, and to allow refining for product yield. For those reasons, asphaltenes separation from heavy oil may help to reduce viscosity and specific gravity. In addition, asphaltenes may have high value because market demand for its derivatives.

Current methods for asphaltene separation include heat and solvent addition to heavy oil, such process may take several days or weeks before completion. Thus, asphaltenes separation takes more time than the required by the market. Therefore, solvents may not be able at time for re-utilization in the next batch of heavy oil. This obligates one to use more new solvent for each batch of heavy oil. In addition, solvent ratio adds the drawback of more and bigger vessels for solvents. Thus, even more solvent may be used if the selected solvent is not the best choice.

Furthermore, incorrect selection of solvents may convey into a lower or higher yield of asphaltenes than the required by the market.

The increasing demand for petroleum products has moved the oil industry towards using heavy oil feedstocks but producers continues to face processing problems and higher costs. Current refining methods using heavy oils are more expensive than methods used for light oil feedstocks. Refineries are required to process large volumes of heavy oil to produce the same volume of final products. Additionally, the industry faces more stringent regulations imposed by government authorities regarding the specifications for fuels and environmental issues.

### SUMMARY

Present disclosure may provide a method for asphaltenes separation from heavy oil through the use of solvents combined with sonication.

The method for solvent selection for asphaltene separation with sonication may be applied to a plurality of heavy oil feedstocks, which may involve different processing stages for the removal of asphaltenes, sulfur, heavy metals, and other impurities. Such solvent selection may rely on a variety of information, which may include market demands, available oil characteristics, available equipment in the plant, solvent properties, and the like.

For an optimal and more efficient solvent selection information mentioned above may be integrated and analyzed by a method to select the optimal solvent. Suitable information may include, solvent charts, graphs and the like.

A chart showing the relationship between yields of asphaltenes versus type of solvent used may be very useful, especially for determining how many barrels of Asphaltenes and De-asphalted oil (DAO) may be required.

A chart showing the relation of solvent ratio versus yield of asphaltenes may be suitable for solvent selection. Such chart may show, asphaltene yields produced versus solvent ratio by the use of only solvent. Such chart may allow solvent selection according to the storage capacity of the plant.

A chart showing the relation of time required for a complete separation versus yield of asphaltenes may be suitable information for solvent selection. Such chart may show, asphaltenes yield produced versus time by the use of only solvent.

A method for solvent selection may include all charts mentioned above and more information for a correct solvent selection. Such method may be included in an algorithm or in a planning sequence for selecting the optimal solvent. By the use of the method described herein an accurate and fast solvent selection may be achieved. Thus, less complex and less expensive equipment may be used for asphaltenes separation, less and smaller vessels may be required for solvent storage, more solvent may be available, because less solvent may be used and more may be ready to be used again.

In one embodiment, a method for selecting a solvent for an asphaltenes separation process comprises receiving, by a computer, market demands, a plurality of oil characteristics, available equipment, or properties of a plurality of solvents, wherein the properties of a solvent include at least one of a relationship between an asphaltene yield percentage and the solvent, a relationship between an asphaltene yield percentage and a solvent ratio, and a relationship between an asphaltene yield percentage and reaction time; analyzing, by a computer, the market conditions to set a production level for asphaltenes and deasphalted oil, wherein the market conditions include demand for asphaltenes and deasphalted oil; analyzing, by a computer, a heavy oil feedstock to determine probable maximum yields based on the oil characteristics of the heavy oil feedstock; analyzing, by a computer, the equipment available for the asphaltenes separation process, wherein a sonic reactor is a piece of equipment used in the asphaltenes separation process; and selecting, by a computer, a solvent based on the production level, the probable maximum yields, the equipment available, and the properties of the plurality of solvents.

In another embodiment, a method for selecting a solvent for an asphaltenes separation process comprises: receiving, by a computer, market demands, a plurality of oil characteristics, available equipment, and properties of a plurality of solvents, wherein the properties of a solvent include at least one of a relationship between an asphaltene yield percentage and the solvent, a relationship between an asphaltene yield percentage and a solvent ratio, and a relationship between an asphaltene yield percentage and reaction time; analyzing, by a computer, the market conditions to set a production level for asphaltenes and deasphalted oil, wherein the market conditions include demand for asphaltenes and deasphalted oil; analyzing, by a computer, a heavy oil feedstock to determine probable maximum yields based on the oil characteristics of the heavy oil feedstock; analyzing, by a computer, the equipment available for the asphaltenes separation process, wherein a sonic reactor is a piece of equipment used in the asphaltenes separation process; and selecting, by a computer, a solvent based on the production level, the probable maximum yields, the equipment available, and the properties of the plurality of solvents.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows a curve of asphaltene yields versus type of solvent used for asphaltene separation.

FIG. 2 shows asphaltene yields versus solvent ratio for asphaltene separation, which may be achieved by the use of only solvent in heavy oil.

FIG. 3 shows asphaltene yields versus time required for asphaltene separation, which may be achieved by the use of only solvent in heavy oil.

FIG. 4 depicts a process flowchart for solvent selection, which shows a variety of factors that may be integrated and analyzed for a correct solvent selection.

FIG. 5A depicts an isometric view of sonic reactor which may be used for asphaltene separation process.

FIG. 5B depicts a front view of sonic reactor which may be used for asphaltene separation process.

FIG. 5C depicts a cross sectional view of sonic reactor which may be used for asphaltene separation process.

FIG. 5D depicts a rear view of sonic reactor which may be used for asphaltene separation process.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of present disclosure.

### Definitions

As used herein, the following terms may have the following definitions:

“Heavy oil feedstocks” may refer to materials that contain heavy oil with a specific gravity of less than 12 API.

“Asphaltenes” may refer to materials present in heavy oils and bitumens, which precipitate in n-alkanes solvent.

“Sonication” may refer to any device or system which produces vibrational energy sufficient to impact one or more desired end uses.

### DESCRIPTION OF THE DRAWINGS

Asphaltene Curves for Solvent Selection.

FIG. 1 depicts asphaltenes yield versus solvents chart 100 with a curve 102 showing the relationship of the asphaltenes yield 104 achieved as percentage of heavy oil, versus the type of solvent 106 used for separating such asphaltenes from heavy oil.

Asphaltenes yield versus solvents chart 100 may be related with any type of solvent 106 and heavy oil feedstocks. Depiction is intended to show an exemplary use of charts for solvent selection.

Currents types of heavy oil may have a specific gravity under 16 API (American petroleum institute) grades, such specific gravity may imply the use of solvents 106 to achieve separation of asphaltenes from heavy oil, such separation may also produce De-asphalted oil (DAO) besides the asphaltenes as the separated products from the heavy oil.

Separation of asphaltenes from heavy oil may be improved by the sonication of heavy oil, such sonication may be generated by a sonic reactor. Sonication may not increase asphaltenes yield 104 or DOA's, sonication may just increase reaction rate between solvents 106 and heavy oil.

Common solvents 106 used for asphaltene separation may include propane (C3H8), butane (C4H8), light naphtha, any n-alkanes and the like. FIG. 1 depicts 3 different solvents 106 as an exemplary illustration of how different solvents 106 produce different yields of asphaltenes. Such solvents 106 are: propane (C3H8), butane (C4H8) and Pentadiene (C5H8), which are represented in FIG. 1 as C3, C4 and C5 correspondingly.

As depicted in FIG. 1 the lighter solvent 106, the higher asphaltenes yield 104 that may be achieved. Therefore, using C3 as solvent 106, near 20% of asphaltene may be separated from heavy oil. In addition, by using a heavier solvent 106 such as C5 a lower asphaltenes yield 104 may be achieved, but the asphaltenes produced by this solvent 106 may possess a heavier specific gravity API, such lower API grade may implies a higher cost per barrel of asphaltene.

Furthermore, a variety of different factors may affect asphaltenes yield 104, such variables may include pressure, temperature, type of heavy oil, available equipment in the plant and the like. Combinations of these variables with solvents 106 may increase or reduce asphaltenes yield 104 and also, may vary the different properties of DAO and asphaltenes.

FIG. 2 depicts asphaltenes yield versus solvent ratio chart 200, which includes Curve 204. Such curve 204 shows the relationship of the asphaltenes yield 104 achieved as percentage of heavy oil, versus the solvent ratio 202 provided by the selected solvent 106.

Asphaltenes yield versus solvent ratio chart 200 may be related with any type of solvent 106 and heavy oil feedstocks. Depiction is intended to show an exemplary use of charts for solvent selection.

Separation of asphaltenes from heavy oil by the use of solvents 106, may imply a solvent ratio 202, the higher ratio the higher volume of solvent 106 that may be used, which means more and bigger vessels may be required for solvent 106 storage. Heaviest solvents require a higher solvent ratio 202 because of higher molecular weights.

3 different solvent ratios 202 are shown as an exemplary illustration of how different solvent ratios 202 produce different asphaltenes yields 104. Such solvent ratios 202 are: 1:2, 1:3 and 1:4. First number “1” corresponds to one part of heavy oil, second number, like 2, 3 and 4, corresponds to solvent parts. Therefore, 1:2 equals to 1 part of heavy oil and 2 of solvent 106.

As shown in curve 204 the lower solvent ratio 202, the lower asphaltenes yield 104 achieved. Therefore, using a lower solvent ratio 202, less asphaltene may be separated from heavy oil using less volume of solvent 106. This also implies the use of less and smaller vessels for solvent 106 storage, which may represent lower operational costs but lower asphaltenes yields 104.

Furthermore, a variety of different factors may affect solvent ratio 202, such variables may include pressure, temperature, type of heavy oil, and the like.

FIG. 3 depicts an asphaltenes yield versus time 300, which includes curve 304. Such curve 304 shows the relationship of the asphaltenes yield 104 achieved as percentage of heavy oil, versus the required time 302 for a complete separation of asphaltenes from heavy oil.

Asphaltenes yield versus time 300 may be related with any type of solvent 106 and heavy oil feedstocks. Depiction is intended to show an exemplary use of charts for solvent selection.

Separation of asphaltenes from heavy oil by the use of solvents 106, may imply a required time 302 for complete separation. As shown in curve 304, the longer the time 302 elapsed, the higher asphaltene yield 104 achieved.

Furthermore, a variety of different factors may affect required time 302, such variables may include pressure, temperature, type of heavy oil, and the like.

Solvent Selection Procedure.

FIG. 4 depicts a flow chart, which may correspond to the solvent selection procedure 400, such procedure may be used and related with an algorithm or with a planning sequence for selecting the more efficient solvent 106. Furthermore, planning sequence may include guides, manuals, and standards.

Solvent selection procedure 400 may be intended to find the more efficient solvent 106, which may reduce required time 302 for a complete separation of asphaltenes. Such separation may use sonication or current separation technologies.

Solvent selection procedure 400 may start by analyzing market demands 402. Market demands 402 may provide number of barrels required for asphaltenes and DAO's. Furthermore, an economic evaluation may be performed to determine cost-benefits for trying to cover all market demands 402. Furthermore, market demands 402 may set required time 302 for the production of asphaltenes and DAO's, as well as the characteristics of each product.

After the selection of the desired production, there may be an evaluation the available oil type 404. In dependency of the API grade and other properties of the available oil, a probable maximum asphaltenes yield 104 and DAO's yield may be set. Then, probable maximum yields may be compared to the required by the market and the cost-benefit analysis.

Subsequently, after the selection of the available oil, a solvent selection 406 may be achieved by the analysis of the information provided by the market demands 402, the properties of the available oil type 404, pressure and temperature involved during process, type of available equipment for the process and the like. For analyzing such information, a variety of data may be used, such data may be able in form of documents, charts, manuals and the like. Charts in FIG. 1, FIG. 2 and FIG. 3 may be used as data for analyzing the selection of optimal type of solvent 106, further information may be provided for a more accurate analysis.

Furthermore, reaction speed increased by a sonic reactor may be analyzed with the overall of variables. Such reaction speed, may improve solvent selection 406 because less time 302 may be required for a complete distillation, allowing the use of cheaper solvents 106. Additionally, due the increased reaction speed on distillation, used solvents 106 may be separated from asphaltenes for a re-utilization in a new batch of Heavy oil.

Subsequently, after solvent selection 406, another evaluation may be done, availability of selected solvent 408. If there is enough volume of selected solvent 106 as the solvent ratio 202 may require for a successful separation (as shown in FIG. 2), then the solvent selection procedure 400 is complete and the processing of heavy oil may start. However, if there is not enough selected solvent 106, then, solvent selection 406 may start again. During the selection of the closest solvent 410, others solvents 106 may be compared with the optimal solvent 106 previously selected. New selected solvent 106 may fill most of the own characteristics present in such optimal solvent 106. If the new selected solvent 106 is available for the process, then the solvent selection procedure 400 is complete and the processing of heavy oil may start.

Furthermore, if required, a combination of two or more solvents 106 may be selected as optimal solvent 106. Such solvents 106 may be used mixed or by separate batches of heavy oil to meet the required volume and characteristics of asphaltenes and DAO's.

FIG. 5A shows an isometric view 502 of a sonic reactor 500, which may be used for asphaltene separation. Additionally, FIG. 5B, FIG. 5C and FIG. 5D show respectively: front view 504, cross sectional view 506 and rear view 508 of sonic reactor 500. Sonic reactor 500 is shown having support structure 510, resonant bar 512, and a set of magnet configuration 514, resonant bar supports 516, and reaction chamber 518 on each end of resonant bar 512.

Sonic reactor 500 may use support structure 510 to hold resonant bar 512 in place using any suitable support as resonant bar supports 516. Suitable configurations for resonant bar supports 516 may include configurations including three or more rubber air cushions. Any suitable magnet configuration 514, activated by a control module (not shown), may cause resonant bar 512 to vibrate, sonicating to heavy oil feedstocks in one or more reaction chamber 518. Suitable configurations for magnet configuration 514 include configurations with at least 3 magnets and power suitable to cause resonant bar 512 to vibrate.

Heavy oil feedstocks in reaction chamber 518 may have previously been chemically altered to allow asphaltenes separation in reaction chamber 518, methods for preparing it for such including the addition of one or more solvents 106 as mentioned above.

### EXAMPLES

Example #1 is an exemplary case of solvent selection procedure 400, where a market demand 402 of 300 bpd (barrels per day) of asphaltenes and 900 bpd of de-asphalted oil (DAO) are required. In addition, the required asphaltene needs to have a specific gravity of 6 API (American petroleum institute) as maximum. The available oil is heavy oil with a specific gravity of 8 API, which may provide a maximum asphaltene yield 104 of 24%. Furthermore, the plant may process heavy oil using a sonic reactor 500.

Using the information provided by the market demand 402 analysis and the characteristics of the available oil type 404, the optimal solvent 106 may be selected using an algorithm that may include the solvent selection procedure 400 (as described in FIG. 4).

In order to achieve the requested volume of DAO's and asphaltenes, a yield of 10% of asphaltenes may be desired for achieving 300 bdd of asphaltenes, such yield may be in concordance with the required specific gravity (6 API). Thus, pentane (CS) may be selected as the optimal solvent 106 because may achieve an asphaltene yield 104 near 10% with the desired specific gravity (As described in FIG. 1). But, if there is no enough capacity to store required pentadiene, then, butane (C4) may be selected. C4 may perform an asphaltene yield 104 of 14%, but with a specific gravity slightly above of the required.

Thus, in order to meet the requirements of the market, both solvents 106 may be used, C4 and C5. Less volume of C5 may be used to achieve less volume of heavier asphaltenes than the produced by using C4. C4 in turn may produce most of the required volume of asphaltenes. Subsequently, asphaltenes and DAO's produced by the use of C4 and C5 may be blended. Heavier asphaltenes from C5 separation may increase specific gravity of lighter asphaltenes produced by C4. Thus, 300 bpd of asphaltenes grade 6 API may be performed by blending the production of 80 bdp of asphaltenes grade 4 API and 220 bdp of asphaltenes grade API 8. Similarly, required production of 900 bdp of DAO's may be achieved by blending productions of C4 and C5.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “creating” or “installing” or “booting” or “configuring” or “preparing” or “mounting” or “capturing” or “saving” or “launching” or “downloading” or “expanding” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored n a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What's claimed is:

1. An asphaltenes separation process comprising:
selecting a solvent, wherein selecting the solvent comprising:
receiving market demands, a plurality of oil characteristics, available equipment, or properties of a plurality of solvents, wherein the properties of a solvent include at least one of a relationship between an asphaltene yield percentage and the solvent, a relationship between an asphaltene yield percentage and a solvent ratio, and a relationship between an asphaltene yield percentage and reaction time;
analyzing the market conditions to set a production level for asphaltenes and deasphalted oil, wherein the market conditions include demand for asphaltenes and deasphalted oil;
analyzing a heavy oil feedstock to determine probable maximum yields based on the oil characteristics of the heavy oil feedstock;
analyzing the equipment available for the asphaltenes separation process, wherein a sonic reactor is a piece of equipment used in the asphaltenes separation process; and
selecting a solvent based on the production level, the probable maximum yields, the equipment available, and the properties of the plurality of solvents;
mixing the selected solvent with the heavy oil feedstock to form a mixture; and
separating the asphaltenes from the mixture using the sonic reactor.

2. The method of claim 1, wherein selecting a solvent further comprises:
analyzing a temperature and a pressure of the asphaltenes separation process.

3. The method of claim 2, wherein selecting a solvent further comprises:
determining the availability of the selected solvent, wherein a total amount of solvent needed to meet the production, accounting for a determined solvent ratio, is determined to determine if the selected solvent has enough volume for the asphaltenes separation process.

4. The method of claim 3, wherein selecting a solvent further comprises:
if the volume of the selected solvent is not enough to meet the production of the asphaltenes separation process, comparing other solvents from the plurality of solvents with the selected solvent to select a new solvent.

5. The method of claim 1, wherein the selected solvent is a combination of two or more solvents from the plurality of solvents.

6. The method of claim 1, wherein the oil characteristics include the specific gravity of the oil.

7. The method of claim 1, wherein relationship between the asphaltene yield percentage and the solvent comprises:
a lighter solvent has a higher yield percentage than a heavier solvent.

8. The method of claim 1, wherein relationship between the asphaltene yield percentage and the solvent comprises:
a heavier solvent produces asphaltenes with a higher specific gravity than a lighter solvent.

9. The method of claim 1, wherein relationship between the asphaltene yield percentage and the solvent ratio comprises:
a lower solvent ratio has a lower yield percentage than a higher solvent ratio.

10. The method of claim 1, wherein relationship between the asphaltene yield percentage and the reaction time comprises:
a longer reaction time has a higher yield percentage than a shorter reaction time.

11. A method for selecting a solvent for an asphaltenes separation process comprising:
receiving, by a computer, market demands, a plurality of oil characteristics, available equipment, and properties of a plurality of solvents, wherein the properties of a solvent include at least one of a relationship between an asphaltene yield percentage and the solvent, a relationship between an asphaltene yield percentage and a solvent ratio, and a relationship between an asphaltene yield percentage and reaction time;
analyzing, by a computer, the market conditions to set a production level for asphaltenes and deasphalted oil, wherein the market conditions include demand for asphaltenes and deasphalted oil;
analyzing, by a computer, a heavy oil feedstock to determine probable maximum yields based on the oil characteristics of the heavy oil feedstock;
analyzing, by a computer, the equipment available for the asphaltenes separation process, wherein a sonic reactor is a piece of equipment used in the asphaltenes separation process; and
selecting, by a computer, a solvent based on the production level, the probable maximum yields, the equipment available, and the properties of the plurality of solvents.

12. The method of claim 11, further comprising:
analyzing, by a computer, a temperature and a pressure of the asphaltenes separation process.

13. The method of claim 12, further comprising:
determining, by a computer, the availability of the selected solvent, wherein a total amount of solvent needed to meet the production, accounting for a determined solvent ratio, is determined to determine if the selected solvent has enough volume for the asphaltenes separation process.

14. The method of claim 13, further comprising:
if the volume of the selected solvent is not enough to meet the production of the asphaltenes separation process, comparing, by a computer, other solvents from the plurality of solvents with the selected solvent to select a new solvent.

15. The method of claim 11, wherein the selected solvent is a combination of two or more solvents from the plurality of solvents.

16. The method of claim 11, wherein the oil characteristics include the specific gravity of the oil.

17. The method of claim 11, wherein relationship between the asphaltene yield percentage and the solvent comprises:
a lighter solvent has a higher yield percentage than a heavier solvent.

18. The method of claim 11, wherein relationship between the asphaltene yield percentage and the solvent comprises:
a heavier solvent produces asphaltenes with a higher specific gravity than a lighter solvent.

19. The method of claim 11, wherein relationship between the asphaltene yield percentage and the solvent ratio comprises:
a lower solvent ratio has a lower yield percentage than a higher solvent ratio.

20. The method of claim 11, wherein relationship between the asphaltene yield percentage and the reaction time comprises:
a longer reaction time has a higher yield percentage than a shorter reaction time.
